(19) United States
(12) Patent Application Publication
(10) Pub. No.: US 2019/0147746 A1
(43) Pub. Date: May 16, 2019

(54) DEVICE FOR IDENTIFYING AN ACCIDENT SITUATION OF AN OPEN ROAD VEHICLE

(71) Applicant: DIGADES GMBH, Zittau (DE)

(72) Inventors: Ulrich WERNICKE, Mittelherwigsdorf (DE); Ruediger KLEIN, Zittau (DE); Lutz BERGER, Olbersdorf (DE)

(73) Assignee: DIGADES GMBH, Zittau (DE)

(21) Appl. No.: 15/752,146

(22) PCT Filed: Aug. 11, 2016
(86) PCT No.: PCT/EP2016/069143

§ 371 Date: Feb. 12, 2018

(30) Foreign Application Priority Data
Aug. 12, 2015 (DE) 10 2015 215 375.4

(51) Int. Cl. G08G 1/00; H04W 4/90; G06K 9/00; B60N 2/00

(52) U.S. Cl. CPC G08G 1/205; B60N 2/002; G06K 9/00791; H04W 4/90

(57) ABSTRACT

The present invention relates to an apparatus and to a method for recognizing an accident situation of a road vehicle (1). The apparatus has a sensor device for detecting at least two accident parameters having at least one operator monitoring sensor (2) for monitoring a climbing down of an operator (20) from an operator's seat (3) as a first accident parameter and having at least one further sensor unit (4) for detecting a deviation of the road vehicle from a predefined operating state of the road vehicle (1) as a second accident parameter. The sensor device is connected to a control unit (5) and this control unit (5) is in turn connected to a data transmission device (6). The control unit (5) is configured to check a presence of the at least two accident parameters and, on the detected presence of the at least two accident parameters, to generate an emergency call signal and to contact an external data reception station (7) by means of the data transmission device (6).

The present invention relates to an apparatus for recognizing a road vehicle.

A system that automatically makes an emergency call in the case of an accident is increasingly being installed in motor vehicles such as automobiles and such an installation may even be legally mandated for new registrations. It is, however, difficult here to determine when an accident has occurred at all to prevent unnecessary emergency calls at public safety answering points. Special demands on determining whether an accident has occurred or not are in particular made for open motor vehicles such as motorcycles, quad bikes or also convertibles due to the chassis of the respective vehicle not being closed at all sides or due to a lack of an operator's cab.

It is therefore the underlying object of the present application to provide an apparatus and a method for recognizing an accident situation which overcome said disadvantages, with which an accident of a vehicle can therefore be reliably detected, and which can make an emergency call as a consequence.

This object is achieved in accordance with the invention by an apparatus in accordance with claim 1 and by a method in accordance with claim 10. Advantageous embodiments and further developments are described in the dependent claims.

An apparatus for recognizing an accident situation of a road vehicle has a sensor device that is configured to detect at least two accident parameters. This sensor device has at least one operator monitoring sensor and at least one further sensor unit for this purpose. The operator monitoring sensor is configured to monitor whether an operator of the road vehicle has climbed down from an operator's seat or whether he is still sitting in the operator's seat. The climbing down of the operator from the operator's seat here servers as the first accident parameter. The at least one further sensor unit is configured to detect a deviation of the road vehicle from a predefined operating state of the road vehicle, with this deviation representing the second accident parameter.

The sensor device is connected to a control unit and this control unit is in turn connected to a data transmission device. The control unit is configured to check a presence of the at least two accident parameters and, on the detected presence of the at least two accident parameters, to generate an emergency call signal and to contact an external data reception station by means of the data transmission device.

A first indicator for an accident can be determined by the detection whether the operator of the road vehicle is in the operator's seat or not. Since with two-wheeler's the operator is in particular frequently hurled from the operator's seat after an accident, this first accident parameter is admittedly a relatively reliable indicator for the actual presence of an accident, but is not a sufficiently accurate one since the operator can also climb down from the operator's seat to makes changes to or around the vehicle. The monitoring of the operating state of the road vehicle or the determining of the deviation from the predefined operating state together with the operator recognition on the operator's seat by a redundant recognition therefore permits a considerable reduction of false alarms and a reliable accident report. Rescue workers linked to this data reception station via the external data reception station can thus be informed and guided to the accident by the making of the emergency call via the data transmission device and by the control unit collecting all the information. A prefiltering of incoming information preferably takes place for recognizing the accident situation, with the prefiltered incoming information additionally being checked for plausibility. This can take place such that sensor data as incoming information are first used for calculating a mean value of these sensor data and such that a value characterizing a time variation of the sensor data is determined. The mean value and the value characterizing the time variation are used for a comparison with new sensor data and a check is made whether these new sensor data are plausible or meaningful, that is, are within a specific interval around the determined values or not. If the vehicle is in an accident situation, the sensor data differ greatly from the values determined in advance, that is, they are outside an interval determined in advance. These sensor data can be determined for some of the sensors or for all the sensors, with relevant states of the sensors being able to be linked and evaluated in a decision matrix so that a generation and transmission of the emergency call signal only results on the presence of deviating sensor data of at least two sensors.

The operator monitoring sensor can be a pressure sensor, a capacitive sensor, an inductive sensor, an RFID tag sensor (radio frequency identification) and/or an NFC tag sensor (near field communication) to be able to detect in a reliable and real time manner whether the operator is in the operator's seat, is still in the operator's seat or has left it. The operator monitoring sensor is preferably arranged in the operator's seat, in particular when it is designed as a pressure sensor, as a capacitive sensor, or as an inductive sensor. The NFC tag sensor is typically likewise arranged in the operator's seat and can detect an NFC tag located in piece of the operator's clothing. The operator monitoring sensor can also run on the basis of a radio frequency identification (RFID) in which a reading device is arranged in the operator's seat and an RFID transponder or the RFID tag sensor is attached to the operator, for example in a piece of clothing.

Provision can be made that the control unit is connected to a position sensor and is configured to transmit a position of the road vehicle determined by the position sensor together with the emergency call signal or as part of the emergency call signal via the data transmission device to the external data reception station. Rescue workers can arrive more quickly at the accident site due to the transmission of the position.

The position sensor can be configured as part of a satellite-based system for position recognition here, preferably as part of a global navigation satellite system (GNSS) such as the global positioning system (GPS), Beidou, or Galileo. This permits a position determination at a very high accuracy.

Alternatively or additionally, the at least one further sensor unit is designed as an acceleration sensor, as a speed sensor, as a temperature sensor, as a deformation sensor, as the position sensor, as a distance sensor, as a tilt sensor, and/or as an attitude sensor. The predefined operating state used for detecting the second accident parameter or the deviation from this operating state of the road vehicle can be an acceleration, a speed, a temperature, a deformation, the position, a distance, a tilt, and/or a determination attitude of the road vehicle. The described values that can be detected by said sensors typically lie in a specific value range on an accident-free vehicle operation so that on a departure from this value range, for example on an exceeding or a falling below of a predefined limit value of the respective value, a further indicator for an accident is present. It can thus be assumed on a determined tilt of the road vehicle by 90° that the vehicle has turned over or it can be assumed on a measured very great temperature increase that the road vehicle has caught fire.

Provision can therefore also be made that the at least one further sensor unit or a third sensor unit detects a third accident parameter and an emergency call signal is only generated and transmitted on the presence of the three accident parameters. More than three accident parameters can naturally also be monitored and used for generating the emergency call signal. Alternatively or additionally, more than three sensor units can naturally also be used. The third accident parameter is preferably one of the already described values here.

The control unit is typically connected to a communication device via which a communication link of the external data reception station to the operator can be established via the data transmission device and the communication device after a reception of the emergency call signal. A check can hereby be made whether the operator is responsive and a deployment of the rescue workers can also be immediately aborted in the case of a false alarm.

The communication device can have a microphone and a loudspeaker to establish voice communication with the operator; however, instead a screen with an input device, for example a touchscreen, can also be provided via which communication with the operator is possible. Alternatively or additionally, the communication device can also comprise a camera by which an image of the environment of the road vehicle can be transmitted to the external data reception station. The microphone and the loudspeaker are preferably connected to the data transmission device via a wireless connection, typically via a Bluetooth connection.

The control unit is typically configured only to generate the emergency call signal with a closed ignition switch of the road vehicle, that is in an operating state of the road vehicle, in which an electrical voltage is applied to all the electrically operable assemblies of the road vehicle. This in particular permits the emergency call only to be sent out with a switched-on ignition or with a started vehicle or with a vehicle ready to start so that false alarms, for example due to a parked or rolled over road vehicle, are avoided. The control unit is particularly preferably configured only to generate and to transmit the emergency call signal with a running engine of the road vehicle.

The described connections between the individual components are typically electrical connections and can be designed in a wireless manner as radio connections or in a wired manner.

An antenna of the data transmission device can be integrated therein, but can also be attached directly, that is in direct touching contact, to the data transmission device or to another described component of the apparatus for recognizing an accident situation. Alternatively to this internal connection of the antenna, the antenna can also be externally connected to the road vehicle and can be connected to the data transmission device in a wireless or wired manner.

The apparatus is typically configured to transmit the emergency call signal in an automated manner on the determined presence of the at least two accident characteristics.

Provision can also be made that the control unit waits for a predefined time period after a first presence of the first accident characteristics or of the second accident characteristic and only generates and transmits the emergency call signal when the at least two accident characteristics were present continuously, that is without interruption, within this predefined time period. It is hereby prevented that the emergency call signal is sent immediately, for example, on a brief leaving of the operator's seat or a brief sloped position of the vehicle during cornering. This time period typically amounts to between 5 seconds and 45 seconds, preferably to between 10 seconds and 30 seconds, particularly preferably to exactly 30 seconds. The apparatus can also be configured such that a user can suppress the emergency call signal within the predefined time period, for example 30 seconds, and can stop the process in the case of an incorrect triggering or a manually sent emergency call signal.

If the road vehicle is equipped with an airbag, the control unit can be configured to understand a triggering of the airbag as an accident parameter. A corresponding sensor unit at the airbag would thus transmit the second accident parameter on an unfolded airbag.

A road vehicle in accordance with the invention, preferably an open, multiwheel, typically two-wheel, three-wheel or four-wheel road vehicle, particularly preferably a motor cycle or a quad bike, is equipped with the described apparatus or the described apparatus is arranged at or in the road vehicle. An open road vehicle should here be understood as all vehicles without an operator's cabin that can be moved on roads. The road vehicle is typically a motor vehicle, that is a vehicle driven by an engine.

A method of recognizing an accident situation of a road vehicle comprises a plurality of steps. In one step, at least two accident parameters are detected by a sensor device. The sensor device has at least one operator monitoring sensor for this purpose for monitoring a climbing down of an operator from an operator's seat as the first accident parameter and at least one further sensor unit for detecting a deviation of the road vehicle from a predefined operating state of the road vehicle as a second accident parameter. In a further step, a presence of the at least two accident parameters is checked by a sensor unit connected to the sensor device. Finally, on a determined presence of the at least two accident parameters, an emergency call signal is generated and an external data reception station is contacted via a data transmission device connected to the control unit.

The method is typically carried out using the described apparatus or the described apparatus is configured to carry out the described method.

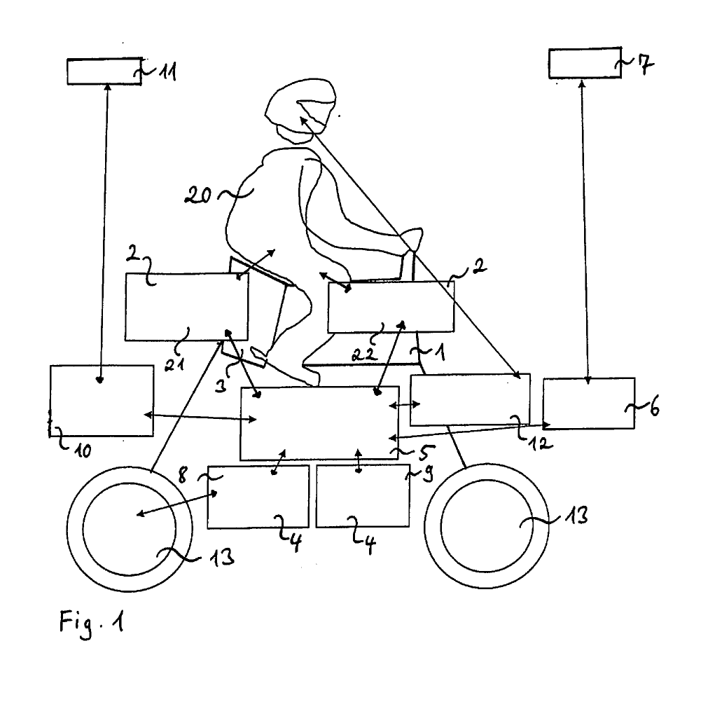

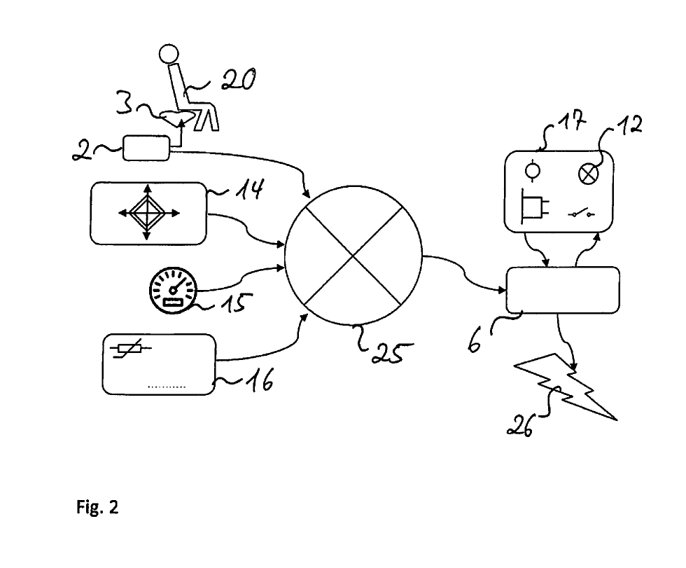

Embodiment of the invention are shown in the drawings and will be explained in the following with reference to FIGS. 1 and 2.

There are shown:

FIG. 1 a schematic representation of a vehicle with an apparatus attached thereto for recognizing an accident situation; and

FIG. 2 a schematic representation of the procedure of the recognition of the accident situation.

In FIG. 1, a road vehicle 1, a motorcycle in the shown embodiment, is shown in a schematic representation in which an operator 20 is seated on an operator's seat 3 and typically also does not leave the operator's seat 3 during the trip. An operator monitoring sensor 2 consisting of a capacitive sensor 21 and an NFC tag sensor 22 on the basis of a radio approach sensor system is located in the operator's seat 3 in the embodiment shown. The capacitive sensor 21 comprises an electrical capacitor whose electrical properties vary as soon as the operator 20 has seated himself in the operator's seat 3 and which thus monitors a sitting in or climbing down of the operator 20 from the operator's seat 3. The NFC tag sensor 22 detects an NFC tag attached inside trousers of the operator 20 and thus monitors whether the operator 20 is in the operator's seat 3. In further embodiments, the operator monitoring sensor 2 can also have an inductive sensor or a pressure sensor. The described apparatus can also be attached in a quad bike or in a convertible.

The operator monitoring sensor 2 is electrically connected to a control unit 5 via two cables. The electrical connection is marked by double arrows in FIG. 1 to indicate that an exchange of information can take place between the operator monitoring sensor 2 and the control unit 5 in both directions. Instead of a wired electrical connection, however, a wireless or cableless radio connection can also be provided.

In further embodiments, a quad bike, that is an off road vehicle without an operator's cabin, or another motor vehicle having at least two wheels can be used instead of the motorcycle. Further components are connected electrically to the control unit 5 via a bus system, for example a controller area network (CAN) bus system, or via a direct connection. The electrical connection takes place here via a cable or via a radio link.

In the embodiment shown in FIG. 1, two further sensor units 4 are electrically connected to the control unit 5. These sensor units 4 are an acceleration sensor 8 and an attitude sensor 9. The acceleration sensor 8 detects a current acceleration by monitoring a wheel 13 of the road vehicle 1 and forwards the determined acceleration to the control unit 5. The attitude sensor 9 likewise checks the orientation or tilt of the road vehicle 1 and forwards the determined value to the control unit 5. The control unit 5 monitors whether the operator 20 is sitting in the operator's seat 3 or not and, if the operator 20 has left the operator's seat 3, understands this as a first accident parameter. It simultaneously checks whether the acceleration measured by the acceleration sensor 8 is within a predefined value range and whether the tilt is in a predefined tilt range.

If these value ranges are left, that is, if predefined threshold values of the acceleration and of the tilt are exceeded or fallen blow, they are treated as second or third accident parameters. If these accident parameters are present over a specific time period, that is, if, for example, the operator 20 has left the operator's seat 3 for more than 5 seconds and if there is ab abrupt drop in acceleration and a change of the tilt by 90° is detected, the control unit 5 generates an emergency call signal in an automated manner since the operator 20 presumably had an accident, was hurled from the motorcycle, and the motorcycle has fallen over.

In further embodiments, only exactly two accident parameters or more than three accident parameters can also be used and a speed, for example a rapid drop in speed, a temperature, for example a sudden increase in temperature, a deformation of the road vehicle 1, a position, for example a departure from a road marked in maps, a triggering of an airbag if the road vehicle 1 is equipped with the airbag, and/or a distance, for example a dramatic falling below of a distance, can also be detected by corresponding sensor units 4 and can be used as accident parameters. A direction of the road vehicle 1 can equally be determined, for example with reference to a compass, which is in particular important on highways.

The control unit 5 is electrically connected to a network area device (NAD) as a data transmission device 6. The generated emergency call signal can be transmitted to a cellular radio network, that is, to an external data reception station 7 of this cellular radio network, by this data transmission device 6. This external data reception station 7 can in particular be the closest rescue coordination center that can be reached via a country-specific emergency call number stored in the control unit.

The control unit 5 is additionally electrically connected to a GNSS position recognition as a position sensor 10. This position sensor 10 receives the current position of the road vehicle 1 via a GNSS satellite 11, for example a GPS satellite, and transmits said position together with or as part of the emergency call signal via the data transmission device 6 to the cellular radio network.

Rescue workers can set up a voice connection to the operator 20 via the data transmission device 6 and the control unit 5. For this purpose, the control unit 5 is electrically connected to a communication device 12 that comprises a headset arranged in the helmet of the operator 20 and consisting of a microphone and a loudspeaker or that comprises a cell phone. The headset or cell phone is connected to the communication device 12 via a Bluetooth link and permits the rescue workers to enter into contact with the operator 20 after the emergency call signal to determine whether an accident has actually taken place, whether the operator 20 is responsive, or whether the operator 20 can provide even further information on the accident.

In further embodiments, alternatively or additionally to the voice connection, a different kind of data link can also be built up, for example a graphic-based data link via a display and/or an input unit such as a touch screen, or images of an environment of the road vehicle 1 can be transmitted by a camera attached to the road vehicle 1 via the data connection. An antenna of the data transmission device 6 is integrated into the data transmission device 6 in the embodiment shown, but can also be arranged externally at the road vehicle 1 in further embodiments.

The transmission of data to a third party service (TPS), for example the emergency call command or a call center, comprises in the embodiment shown the position of the road vehicle 1, a direction of travel of the road vehicle 1 in order also to immediately show the rescue workers the correct lane of a highway, and typically also a vehicle-specific identification number. Further information detected by the sensor units 4 can optionally also be transmitted. In addition to a digital data transmission via NAD, the voice connection set up can be used to speak to the operator 20. The generation of the emergency call signal, however, only takes place when an ignition switch of the road vehicle 1 is closed, that is, when all the components of onboard electrics are supplied with an electrical voltage. A danger situation or an accident should therefor only be detectable with a switched-on ignition, in particular only with a running engine of a motor vehicle.

The apparatus shown is therefore in a position to recognize an operator relationship toward the vehicle, a movement and an attitude of the vehicle, and a position of the vehicle as well as to establish a communication link in the form of a voice link to the operator 20. A distinction can be made between a sporty operating mode and a critical situation such as an accident by a redundant arrangement of a plurality of sensors at the control unit 5.

An apparatus and a method for recognizing an accident or a danger situation of the road vehicle 1 is thus described in which a plurality of features from the connected sensors are used to distinguish whether it is a danger situation. The attitude of the road vehicle 1, that is standing, lying, or driving, and the position of the operator 20, that is sitting up, next to the road vehicle 1, or being close to (i.e. in a radius of up to 2 meters) of the road vehicle 1, and preferably their combination with other information are in particular used for a secure recognition of critical situations.

It is shown in a schematic view in FIG. 2 how the recognition of the accident situation takes place in a possible embodiment. Recurring features are shown with the same reference numerals as in FIG. 1 in this Figure. The accident event can be determined using a central crash algorithm 25. The crash algorithm 25 is implemented in the control unit 5 for this purpose. The crash algorithm 25 receives signals from the sensors as input values, for example a signal whether the operator 20 is in the operator's seat 3 from the operator monitoring sensor 2. A motion sensor 14, a speed sensor 15, and a temperature sensor 16 are additionally provided in the embodiment shown. Further sensor units 4 can provide a deformation sensor or a distance sensor.

The sensor information is prefiltered and checked for plausibility before the crash algorithm makes a conclusion on the accident event via a decision matrix on the presence of specific sensor signals. If an accident event is concluded, an accident signal is generated and transmitted to the data transmission device 6. The latter outputs a warning signal to an operating unit 17 in the embodiment shown that has the communication apparatus 12. In addition, the accident signal is sent to the external data reception station 7 by the data transmission device 6.

If, for example, the operator monitoring sensor 2 has recognized an abrupt change of the operator position and if a tilt of the vehicle, for example of a motorcycle, is determined by the motion sensor 14 and/or if a strong and abrupt reduction in speed is registered by the speed sensor 15, the presence of the accident situation can be assumed and the accident signal 26 is generated and transmitted. In further embodiments, an abruptly determined position of the vehicle on its side and a signal of the operator monitoring sensor 2 that the operator was in the operator's seat 3 for a longer period and is now no longer recognized by the operator monitoring sensor can also result in the sending of the emergency call signal.

Features of the different embodiments only disclosed in the embodiment examples can be combined with one another and claimed individually.

1. An apparatus for recognizing an accident situation of a road vehicle (1), comprising a sensor device for detecting at least two accident parameters that has at least one operator monitoring sensor (2) for monitoring a climbing down of an operator (20) from an operator's seat (3) as a first accident parameter; and
that has at least one further sensor unit (4) for detecting a deviation of the road vehicle (1) from a predefined operating state of the road vehicle (1) as a second accident parameter,
wherein the sensor device is connected to a control unit (5),
and the control unit (5) is connected to a data transmission device (6),
with the control unit (5) being configured to check a presence of the at least two accident parameters and,
on the presence of the at least two accident parameters, to generate an emergency call signal and to contact an external data reception station (7) by means of the data transmission device (6).

2. An apparatus in accordance with claim 1, characterized in that the operator monitoring sensor (2) is configured as a pressure sensor, as a capacitive or inductive sensor (21) that is preferably arranged in the operator's seat (3), as an RFID tag sensor and/or as an NFC tag sensor (22).

3. An apparatus in accordance with claim 1, characterized in that the control unit (5) is connected to a position sensor (10) and is configured to transmit a position of the road vehicle (1) determined by the position sensor (10) together with the emergency call signal via the data transmission device (6) to the external data reception station (7).

4. An apparatus in accordance with claim 3, characterized in that the position sensor (10) is configured as part of a satellite-based system (11) for position recognition, preferably as part of a global navigation satellite system.

5. An apparatus in accordance with claim 1, characterized in that the at least one further sensor unit (4) is configured as an acceleration sensor (8), as a speed sensor, as a temperature sensor, as a deformation sensor, as the position sensor (10), as a distance sensor, as a tilt sensor and/or as an attitude sensor (9); and in that the predefined operating state of the road vehicle (1) used for detecting the second accident parameter is an acceleration, a speed, a temperature, a deformation, the position, a distance, a tilt and/or a determined attitude of the road vehicle (1).

6. An apparatus in accordance with claim 1, characterized in that the control unit (5) is connected to a communication device (12), with a communication connection of the external data reception station (7) to the operator (20) being able to be established after a reception of the emergency call signal via the data transmission device (6) and the communication device (12).

7. An apparatus in accordance with claim 6, characterized in that the communication device (12) has a microphone and a loudspeaker and the microphone and the loudspeaker are preferably connected to the data transmission device (6) via a Bluetooth connection.

8. An apparatus in accordance with claim 1, characterized in that the control unit (5) is configured only to generate the emergency call signal with a closed ignition switch of the road vehicle (1).

9. A road vehicle (1) comprising an apparatus in accordance with claim 1.

10. A method of recognizing an accident situation of a road vehicle (1), in which at least two accident parameters are detected by a sensor device, with the sensor device having at least one operator monitoring sensor (2) for monitoring a climbing down of an operator (20) from an operator's seat (3) as a first accident parameter, and having at least one further sensor unit (4) for detecting a deviation of the road vehicle (1) from a predefined operating state of the road vehicle as a second accident parameter; and
a presence of the at least two accident parameters is checked by a control unit (5) connected to the sensor device; and
on a presence of the at least two accident parameters, an emergency call signal is generated and an external data reception station (7) is contacted via a data transmission device (6) connected to the control unit (5).
